(19) United States
(12) Patent Application Publication
(10) Pub. No.: US 2020/0115474 A1
(43) Pub. Date: Apr. 16, 2020

(54) METHOD FOR PRODUCING ORGANIC-INORGANIC HYBRID HYDROGEL

(71) Applicant: DIC Corporation, Tokyo (JP)

(72) Inventor: Toru TAKEHISA, Chiba (JP)

(21) Appl. No.: 16/627,119

(22) PCT Filed: Jun. 12, 2018
(86) PCT No.: PCT/JP2018/022365

§ 371 Date: Dec. 27, 2019

(30) Foreign Application Priority Data
Jul. 3, 2017 (JP) 2017-130342

(51) Int. Cl. C08F 2/44; C08F 2/16

(52) U.S. Cl. CPC C08F 2/44; C08F 2/16

(57) ABSTRACT

A method for producing an organic-inorganic hybrid hydrogel includes mixing an aqueous solution (A) containing a water-soluble organic monomer (a1) and a phosphonic acid-modified hectorite (a2), a polymerization initiator (B), and a polymerization promotor (C) with each other. The aqueous solution (A) has a viscosity of 1,000 mPa·s or less when stored at 50° C. for one week after preparation. The polymerization initiator (B) has a solubility of 50 g/100 ml or more in water at 20° C. The molar ratio [(B)/(a1)] of the polymerization initiator (B) to the water-soluble organic monomer (a1) is in the range of 0.01 to 0.1. The aqueous solution in the state immediately before being subjected to polymerization can be stored for a long term, and thus has excellent operation properties and has no restriction on the place where a hydrogel is produced, and therefore can be applied to various industrial uses.

### TECHNICAL FIELD

The present invention relates to a method for producing an organic-inorganic hybrid hydrogel.

### BACKGROUND ART

A gel has intermediate properties between the properties of liquids and those of solids, and is in a stable state such that it has a material, such as an organic polymer, constituting a three-dimensional network in a solvent, such as water. Particularly, a gel having water as a solvent is called a hydrogel, and the development of the use of a hydrogel as medical, food, and sports-related functional materials and the like has been made. Especially, for obtaining a hydrogel having uniform transparency, strong mechanical properties, water absorption properties, biocompatibility, or the like, the formation of a composite of a hydrogel and various materials and improvements of the crosslinked structure have been attempted.

For example, an invention of an organic-inorganic hybrid hydrogel having water included in a three-dimensional network formed from a composite of a water-soluble organic polymer and a water-swellable clay mineral is described (see, for example, PTL 1). There is a description that the organic-inorganic hybrid hydrogel described in PTL 1 has a light transmission of 95% or more, a water absorbing capacity which is 10 times or more the dry weight of the hydrogel, and can stretch 10 times or more.

However, for the reason that the above hydrogel is produced through radical polymerization of an organic monomer, synthesis of the hydrogel has been considered possible only in the absence of molecular oxygen. Accordingly, the application of the hydrogel to industrial uses, for example, the use in civil engineering work sites or construction work sites, is difficult. In addition, for permitting a water-swellable clay mineral to be included in water, it is necessary that the water-swellable clay mineral be dispersed in water as uniformly as possible, but the rate of dispersion of the water-swellable clay mineral is small, and further appropriate stirring is needed for preventing formation of undispersed lumps of the clay mineral, and therefore it is difficult to perform such operations in civil engineering work sites or construction work sites. Furthermore, when the water-swellable clay mineral is dispersed in water, the resultant dispersion is likely to increase in its viscosity with the passage of time and to forma so-called house-of-cards structure by itself, leading to gelation, and thus to store the water-swellable clay mineral in the state of being dispersed in water for a long term is disadvantageous.

### CITATION LIST

### Patent Literature

PTL 1: JP-A-2002-053629

### SUMMARY OF INVENTION

### Technical Problem

A task to be achieved by the present invention is to provide a means by which an organic-inorganic hybrid hydrogel can be produced with ease even in an air atmosphere in any place.

### Solution to Problem

The present inventors have found that the task can be achieved by a method for producing an organic-inorganic hybrid hydrogel, which comprises the step of mixing an aqueous solution containing a specific organic monomer and clay mineral, a polymerization initiator, and a polymerization promotor with each other, and the present invention has been completed.

Specifically, in the present invention, there is provided a method for producing an organic-inorganic hybrid hydrogel, which comprises the step of mixing an aqueous solution (A) containing a water-soluble organic monomer (a1) and a phosphonic acid-modified hectorite (a2), a polymerization initiator (B), and a polymerization promotor (C) with each other, wherein the aqueous solution (A) has a viscosity of 1,000 mPa·s or less when stored at 50° C. for one week after preparation, the polymerization initiator (B) has a solubility of 50 g/100 ml or more in water at 20° C., and the molar ratio [(B)/(a1)] of the polymerization initiator (B) to the water-soluble organic monomer (a1) is in the range of 0.01 to 0.1.

### Advantageous Effects of Invention

The method for producing an organic-inorganic hybrid hydrogel of the invention is advantageous in that the aqueous solution in the state immediately before being subjected to polymerization can be stored for a long term, and thus has excellent operation properties and has no restriction on the place where a hydrogel is produced, and the like, and therefore can be applied to various industrial uses, such as civil engineering work sites.

### DESCRIPTION OF EMBODIMENTS

The method for producing an organic-inorganic hybrid hydrogel of the invention comprises the step of mixing an aqueous solution (A) containing a water-soluble organic monomer (a1) and a phosphonic acid-modified hectorite (a2), a polymerization initiator (B), and a polymerization promotor (C) with each other, wherein the aqueous solution (A) has a viscosity of 1,000 mPa·s or less when stored at 50° C. for one week after preparation, the polymerization initiator (B) has a solubility of 50 g/100 ml or more in water at 20° C., and the molar ratio [(B)/(a1)] of the polymerization initiator (B) to the water-soluble organic monomer (a1) is in the range of 0.01 to 0.1.

In the method of the invention, the water-soluble organic monomer (a1) undergoes polymerization in a mixture (M) of the aqueous solution (A), the polymerization initiator (B), and the polymerization promotor (C), and forms a three-dimensional network structure, together with the phosphonic acid-modified hectorite (a2), and therefore an organic-inorganic hydrogel can be obtained with ease.

The aqueous solution (A) contains the water-soluble organic monomer (a1) and the phosphonic acid-modified hectorite (a2), and, for causing polymerization of the water-soluble organic monomer (a1) in the mixture (M) to satisfactorily proceed so as to obtain an organic-inorganic hydrogel having a three-dimensional network structure, it is important that the aqueous solution (A) has a viscosity of 1,000 mPa·s or less, preferably 500 mPa·s or less, more preferably 300 mPa·s or less. When the aqueous solution which has been stored at 50° C. for one week has a viscosity of more than 1,000 mPa·s, the aqueous solution (A) has poor storage stability, making it difficult to use the resultant hydrogel in civil engineering work sites or the like. The viscosity of the aqueous solution is a value measured by a Brookfield type viscometer.

Examples of the water-soluble organic monomers (a1) include monomers having (a)an (meth)acrylamide group, monomers having (a)an (meth)acryloyloxy group, and acrylic monomers having a hydroxyl group.

Examples of the monomers having (a)an (meth)acrylamide group include acrylamide, N,N-dimethylacrylamide, N,N-diethylacrylamide, N-methylacrylamide, N-ethylacrylamide, N-isopropylacrylamide, N-cyclopropylacrylamide, N,N-dimethylaminopropylacrylamide, N,N-diethylaminopropylacrylamide, acryloylmorpholine, methacrylamide, N,N-dimethylmethacrylamide, N,N-diethylmethacrylamide, N-methylmethacrylamide, N-ethylmethacrylamide, N-isopropylmethacrylamide, N-cyclopropylmethacrylamide, N,N-dimethylaminopropylmethacrylamide, and N,N-diethylaminopropylmethacrylamide.

Examples of the monomers having (a) an (meth)acryloyloxy group include methoxyethyl acrylate, ethoxyethyl acrylate, methoxyethyl methacrylate, ethoxyethyl methacrylate, methoxymethyl acrylate, and ethoxymethyl acrylate.

Examples of the acrylic monomers having a hydroxyl group include hydroxyethyl acrylate and hydroxyethyl methacrylate.

Of these, from the viewpoint of the solubility and the physical properties of the obtained organic-inorganic hydrogel, a monomer having (a)an (meth)acrylamide group is preferably used, acrylamide, N,N-dimethylacrylamide, N,N-diethylacrylamide, N-isopropylacrylamide, or acryloylmorpholine is more preferably used, N,N-dimethylacrylamide or acryloylmorpholine is further preferably used, and, from the viewpoint of causing the polymerization to smoothly proceed, N,N-dimethylacrylamide is especially preferably used.

The above-mentioned water-soluble organic monomers (a1) may be used individually or in combination.

The phosphonic acid-modified hectorite (a2) forms a three-dimensional network structure, together with a polymer of the water-soluble organic monomer, and serves as a constituent of an organic-inorganic hydrogel.

As the phosphonic acid-modified hectorite (a2), for example, pyrophosphoric acid-modified hectorite, etidronic acid-modified hectorite, alendronic acid-modified hectorite, methylenediphosphonic acid-modified hectorite, phytic acid-modified hectorite, or the like can be used. These phosphonic acid-modified hectorites (a2) may be used individually or in combination.

The aqueous solution (A) has excellent storage stability by virtue of using the phosphonic acid-modified hectorite (a2), and can contain another water-swellable clay mineral in such an amount that the storage stability is not adversely affected.

The content of the water-soluble organic monomer (a1) in the aqueous solution (A) is preferably 1 to 50% by mass, more preferably 5 to 30% by mass. When the content of the water-soluble organic monomer (a1) in the aqueous solution (A) is 1% by mass or more, a hydrogel having excellent mechanical properties can be advantageously obtained. On the other hand, when the content of the water-soluble organic monomer in the aqueous solution (A) is 50% by mass or less, the aqueous solution can be advantageously easily prepared.

The content of the phosphonic acid hectorite (a2) in the aqueous solution (A) is preferably 1% by mass or more, more preferably 2% by mass or more, in view of further improving the mechanical properties of the resultant hydrogel. Further, the content of the phosphonic acid hectorite (a2) in the aqueous solution (A) is preferably 20% by mass or less, more preferably 10% by mass or less, in view of further suppressing an increase of the viscosity of the aqueous solution (A).

Further, the aqueous solution (A) may contain an organic solvent other than water, and examples of the organic solvents include alcohol compounds, such as methanol, ethanol, propanol, isopropyl alcohol, and 1-butanol; ether compounds, such as ethyl ether and ethylene glycol monoethyl ether; amide compounds, such as dimethylformamide and N-methylpyrrolidone; and ketone compounds, such as acetone and methyl ethyl ketone.

Of these, from the viewpoint of the solubility of the phosphonic acid hectorite (a2), as an organic solvent miscible with water, alcohol compounds are preferred, methanol, ethanol, n-propyl alcohol, and isopropyl alcohol are more preferred, and methanol and ethanol are further preferred.

The above-mentioned organic solvents may be used individually or in combination.

The aqueous solution (A) can be easily prepared by, for example, mixing together the water-soluble organic monomer (a1), the phosphonic acid hectorite (a2), and water and stirring the resultant mixture.

It is important that the polymerization initiator (B) has a solubility of 50 g/100 ml or more in water at 20° C. for causing polymerization of the water-soluble organic monomer (a1) to satisfactorily proceed even in an air atmosphere.

Examples of the polymerization initiators (B) include water-soluble peroxides and water-soluble azo compounds, each having a solubility of 50 g/100 ml or more in water at 20° C.

Examples of the water-soluble peroxides include ammonium peroxodisulfate, sodium peroxodisulfate, and t-butylhydroperoxide.

Examples of the water-soluble azo compounds include 2,2′-azobis(2-methylpropionamidine) dihydrochloride and 4,4′-azobis(4-cyanovaleric acid).

Of these, from the viewpoint of the interaction with the phosphonic acid hectorite (a2), water-soluble peroxides are preferred, and ammonium peroxodisulfate and sodium peroxodisulfate are more preferred.

The above-mentioned polymerization initiators (B) may be used individually or in combination.

It is important that the molar ratio [(B)/(a1)] of the polymerization initiator (B) to the water-soluble organic monomer (a1) in the mixture (M) is in the range of 0.01 to 0.1 for causing polymerization of the water-soluble organic monomer (a1) to satisfactorily proceed even in an air atmosphere, and the molar ratio is preferably in the range of 0.01 to 0.05.

Examples of the polymerization promotors (C) include tertiary amine compounds, thiosulfates, and ascorbic acid compounds.

Examples of the tertiary amine compounds include N,N,N′,N′-tetramethylethylenediamine and 3-dimethylaminopropionitrile.

Examples of the thiosulfates include sodium thiosulfate and ammonium thiosulfate.

Examples of the ascorbic acid compounds include L-ascorbic acid and sodium L-ascorbate.

Of these, from the viewpoint of the affinity and interaction with the water-swellable clay mineral, tertiary amine compounds are preferred, and N,N,N′,N′-tetramethylethylenediamine is more preferred.

The above-mentioned polymerization promotors (C) may be used individually or in combination.

The content of the polymerization promotor (C) in the mixture (M) is preferably 0.01 to 1% by mass, more preferably 0.05 to 0.5% by mass. When the content of the polymerization promotor (C) in the mixture (M) is 0.01% by mass or more, a synthesis of the hydrogel from the organic monomer can be advantageously efficiently promoted. On the other hand, when the content of the polymerization promotor (C) in the mixture (M) is 1% by mass or less, the handling properties are advantageously improved so that the dispersion can be used without suffering aggregation before being subjected to polymerization.

With respect to the step of mixing the aqueous solution (A), the polymerization initiator (B), and the polymerization promotor (C) with each other to prepare a mixture (M), the polymerization initiator (B) and the polymerization promotor (C) may be mixed as such into the aqueous solution (A), or an aqueous solution of the polymerization initiator (B) and an aqueous solution of the polymerization promotor (C) may be mixed into the aqueous solution (A).

The mixture (M) contains the above-mentioned aqueous solution (A), polymerization initiator (B), and polymerization promotor (C), and, if necessary, may further contain an organic solvent, an organic crosslinking agent, an antiseptic agent, a thickener, and the like.

Examples of the organic solvents include alcohol compounds, such as methanol, ethanol, propanol, isopropyl alcohol, and 1-butanol; ether compounds, such as ethyl ether and ethylene glycol monoethyl ether; amide compounds, such as dimethylformamide and N-methylpyrrolidone; and ketone compounds, such as acetone and methyl ethyl ketone.

Of these, from the viewpoint of the affinity with the phosphonic acid hectorite (a2), alcohol compounds are preferred, methanol, ethanol, n-propyl alcohol, and isopropyl alcohol are more preferred, and methanol and ethanol are further preferred.

These organic solvents may be used individually or in combination.

In the method for producing an organic-inorganic hybrid hydrogel of the invention, the aqueous solution (A), the polymerization initiator (B), and the polymerization promotor (C) are mixed with each other, causing the water-soluble organic monomer (a1) in the aqueous solution (A) to undergo polymerization, and the method does not need a post-step, such as heating or ultraviolet light irradiation, and thus has excellent operation properties.

The polymerization temperature is preferably 10 to 80° C., more preferably 20 to 80° C. When the polymerization temperature is 10° C. or higher, a radical reaction can advantageously proceed in a chain-reaction-like manner. On the other hand, when the polymerization temperature is 80° C. or lower, the polymerization can be conducted without causing the water contained in the dispersion to boil.

The polymerization time varies depending on the type of the polymerization initiator (B) or polymerization promotor (C), but the polymerization is conducted for several tens of seconds to 24 hours. Particularly, in the case of radical polymerization using heating or redox, the polymerization time is preferably 1 to 24 hours, more preferably 5 to 24 hours. When the polymerization time is 1 hour or more, a polymerization product of the phosphonic acid-modified hectorite (a2) and the water-soluble organic monomer (a1) can advantageously form a three-dimensional network. On the other hand, the polymerization reaction is almost completed in 24 hours, and therefore the polymerization time is preferably 24 hours or less.

In the method for producing an organic-inorganic hybrid hydrogel of the invention, the aqueous solution (A) has excellent storage stability, and therefore, after preparation, the aqueous solution (A) can be, for example, transported to a site where it is used. Further, an organic-inorganic hybrid hydrogel can be produced with ease by the method even in an air atmosphere, and therefore the method can be advantageously used in application in places such as civil engineering work sites or construction work sites.

### EXAMPLES

Hereinbelow, the present invention will be described in more detail with reference to the following specific Examples. The viscosity of an aqueous solution is a value measured by a Brookfield type viscometer (“TV-22”, manufactured by Toki Sangyo Co., Ltd.).

### Example 1: Production and Evaluation of an Organic-Inorganic Hybrid Hydrogel (1)

90 mL of pure water, 2.4 g of phosphonic acid-modified hectorite (“LAPONITE RDS”, manufactured by BYK Japan KK), and 10 g of dimethylacrylamide (DMAA) were placed in a flat bottom glass vessel and stirred to prepare a uniform and transparent aqueous solution (A-1). A viscosity of the aqueous solution (A-1) at a water temperature of 25° C. was measured, and, as a result, the viscosity was found to be 1.5 mPa·s.

The aqueous solution (A-1) was sealed in the vessel and stored in a 50° C. thermostat. After one week had passed, the aqueous solution was removed from the thermostat, and a viscosity of the aqueous solution at a water temperature of 25° C. was further measured. As a result, the viscosity was found to be 200 mPa·s, and no marked increase of the viscosity occurred in one week.

Subsequently, 10 mL of pure water and 0.5 g of sodium persulfate (hereinafter, abbreviated to “NPS”) were placed in another flat bottom glass vessel and stirred to prepare a uniform and transparent aqueous NPS solution. 10 mL of pure water and 80 μL of tetramethylethylenediamine (hereinafter, abbreviated to “TEMED”) were placed in still another flat bottom glass vessel and stirred to prepare a uniform aqueous TEMED solution.

All of the aqueous solution (A-1) was placed in a 200 mL glass beaker, and the above-prepared aqueous NPS solution and aqueous TEMED solution were added to the aqueous solution while stirring, and the stirring was continued until a uniform mixture was obtained. After stirring, without putting a cover on the beaker, the resultant mixture was allowed to stand as it was at room temperature for 24 hours, producing an organic-inorganic hybrid hydrogel. After 24 hours had lapsed, the solution was checked, and thus a colorless and transparent organic-inorganic hybrid hydrogel (1) was obtained.

### Example 2: Production and Evaluation of an Organic-Inorganic Hybrid Hydrogel (2)

A uniform and transparent aqueous solution (A-2) was prepared by substantially the same method as in Example 1 except that the amount of the phosphonic acid-modified hectorite used was changed to 4.8 g. A viscosity of the aqueous solution (A-2) at a water temperature of 25° C. was measured, and, as a result, the viscosity was found to be 1.8 mPa·s.

The aqueous solution (A-2) was sealed in the vessel and stored in a 50° C. thermostat. After one week had passed, the aqueous solution was removed from the thermostat, and a viscosity of the aqueous solution at a water temperature of 25° C. was further measured. As a result, the viscosity was found to be 300 mPa·s, and no marked increase of the viscosity occurred in one week.

Subsequently, in accordance with the same method as in Example 1, the aqueous NPS solution and aqueous TEMED solution were added to the aqueous solution (A-2), and stirring was continued until a uniform mixture was obtained. After stirring, without putting a cover on the beaker, the resultant mixture was allowed to stand as it was at room temperature for 24 hours, producing an organic-inorganic hybrid hydrogel. After 24 hours had lapsed, the solution was checked, and thus a colorless and transparent organic-inorganic hybrid hydrogel (2) was obtained.

### Example 3: Production and Evaluation of an Organic-Inorganic Hybrid Hydrogel (3)

90 mL of pure water, 2.4 g of phosphonic acid-modified hectorite (“LAPONITE S-482”, manufactured by BYK Japan KK), and 10 g of DMAA were placed in a flat bottom glass vessel and stirred to prepare a uniform and transparent aqueous solution (A-3). A viscosity of the aqueous solution (A-3) at a water temperature of 25° C. was measured, and, as a result, the viscosity was found to be 1.5 mPa·s.

The aqueous solution (A-3) was sealed in the vessel and stored in a 50° C. thermostat. After one week had passed, the aqueous solution was removed from the thermostat, and a viscosity of the aqueous solution was further measured at a water temperature of 25° C. As a result, the viscosity was found to be 20 mPa·s, and no marked increase of the viscosity occurred in one week.

Subsequently, 10 mL of pure water and 0.5 g of NPS were placed in another flat bottom glass vessel and stirred to prepare a uniform and transparent aqueous NPS solution. 10 mL of pure water and 80 μL of TEMED were placed in still another flat bottom glass vessel and stirred to prepare a uniform aqueous TEMED solution.

All of the aqueous solution (A-3) was placed in a 200 mL glass beaker, and the above-prepared aqueous NPS solution and aqueous TEMED solution were added to the aqueous solution while stirring, and the stirring was continued until a uniform mixture was obtained. After stirring, without putting a cover on the beaker, the resultant mixture was allowed to stand as it was at room temperature for 24 hours, producing an organic-inorganic hybrid hydrogel. After 24 hours had lapsed, the solution was checked, and thus a colorless and transparent organic-inorganic hybrid hydrogel (3) was obtained.

### Example 4: Production and Evaluation of an Organic-Inorganic Hybrid Hydrogel (4)

An aqueous solution (A-1) was prepared in a flat bottom glass vessel by the same method as in Example 1.

Subsequently, 10 mL of pure water and 1.0 g of NPS were placed in another flat bottom glass vessel and stirred to prepare a uniform and transparent aqueous NPS solution. 10 mL of pure water and 80 μL of TEMED were placed in still another flat bottom glass vessel and stirred to prepare a uniform aqueous TEMED solution.

All of the aqueous solution (A-1) was placed in a 200 mL glass beaker, and the above-prepared aqueous NPS solution and aqueous TEMED solution were added to the aqueous solution while stirring, and the stirring was continued until a uniform mixture was obtained. After stirring, without putting a cover on the beaker, the resultant mixture was allowed to stand as it was at room temperature for 24 hours, producing an organic-inorganic hybrid hydrogel. After 24 hours had lapsed, the solution was checked, and thus a colorless and transparent organic-inorganic hybrid hydrogel (4) was obtained.

### Example 5: Production and Evaluation of an Organic-Inorganic Hybrid Hydrogel (5)

A uniform and transparent aqueous solution (A-4) was prepared by substantially the same method as in Example 1 except that, instead of DMAA, 20 g of acryloylmorpholine (hereinafter, abbreviated to “ACMO”) was used as a water-soluble organic monomer. A viscosity of the aqueous solution (A-4) at a water temperature of 25° C. was measured, and, as a result, the viscosity was found to be 5.1 mPa·s.

The aqueous solution (A-4) was sealed in the vessel and stored in a 50° C. thermostat. After one week had passed, the aqueous solution was removed from the thermostat, and a viscosity of the aqueous solution at a water temperature of 25° C. was further measured. As a result, the viscosity was found to be 850 mPa·s, and no marked increase of the viscosity occurred in one week.

Subsequently, in accordance with the same method as in Example 1, the aqueous NPS solution and aqueous TEMED solution prepared by the same method as in Example 1 were added to all of the aqueous solution (A-4), and stirring was continued until a uniform mixture was obtained. After stirring, without putting a cover on the beaker, the resultant mixture was allowed to stand as it was at room temperature for 24 hours, producing an organic-inorganic hybrid hydrogel. After 24 hours had lapsed, the solution was checked, and thus a colorless and transparent organic-inorganic hybrid hydrogel (5) was obtained.

### Comparative Example 1: Production and Evaluation of an Organic-Inorganic Hybrid Hydrogel (R-1)

An aqueous solution (A-1) was prepared in a flat bottom glass vessel by the same method as in Example 1.

Then, all of the aqueous solution (A-1) was placed in in a 200 mL glass beaker, and 0.1 g of potassium persulfate (KPS) and 80 μL of TEMED were added to the aqueous solution while stirring, and the stirring was continued until a uniform mixture was obtained.

Subsequently, 10 mL of pure water and 0.5 g of potassium persulfate (hereinafter, abbreviated to “KPS”) were placed in another flat bottom glass vessel and stirred to prepare a uniform and transparent aqueous KPS solution. 10 mL of pure water and 80 μL of TEMED were placed in still another flat bottom glass vessel and stirred to prepare a uniform aqueous TEMED solution.

All of the aqueous solution (A-1) was placed in a 200 mL glass beaker, and the above-prepared aqueous KPS solution and aqueous TEMED solution were added to the aqueous solution while stirring, and the stirring was continued until a uniform mixture was obtained. After stirring, without putting a cover on the beaker, the resultant mixture was allowed to stand as it was at room temperature for 24 hours, producing an organic-inorganic hybrid hydrogel (R-1).

### Comparative Example 2: Production and Evaluation of an Organic-Inorganic Hybrid Hydrogel (R-2)

A uniform and transparent aqueous solution (RA-1) was prepared by substantially the same method as in Example 1 except that the phosphonic acid-modified hectorite (“LAPONITE RDS”, manufactured by BYK Japan KK) used in Example 1 was changed to synthetic hectorite (“LAPONITE RD”, manufactured by BYK Japan KK). The aqueous solution (RA-1) was sealed in the vessel and stored in a 50° C. thermostat. After one week had passed, the aqueous solution was removed from the thermostat, and a viscosity of the aqueous solution at a water temperature of 25° C. was further measured. As a result, the viscosity was found to be 20,000 mPa·s, and thus the aqueous solution had almost no fluidity, and it was difficult to use the aqueous solution in the production of an organic-inorganic hybrid hydrogel.

### [Evaluation of the Organic-Inorganic Hybrid Hydrogel]

The above-obtained organic-inorganic hybrid hydrogel was pressed using a glass rod, and the state of the resultant hydrogel was evaluated in accordance with the criteria shown below. A gel obtained by the polymerization which has unsatisfactorily proceeded is so brittle that it is easily broken.

[symbol] : Not broken.

◯: A broken portion is less than 5% by mass.

Δ: A broken portion is 5% or more to 10% or less by mass.

x: A broken portion is 10% by mass or more.

The results obtained in the above-mentioned evaluation are shown in Table 1.

TABLE 1

| | | | Example | Example | Example | Example | Example | Comparative | Comparative |
|---|---|---|---|---|---|---|---|---|---|
| | | | 1 | 2 | 3 | 4 | 5 | Example 1 | Example 2 |
| Organic-inorganic hybrid hydrogel | | | (1) | (2) | (3) | (4) | (5) | (R-1) | (R-2) |
| Aqueous solution (A) | | | (A-1) | (A-2) | (A-3) | (A-1) | (A-4) | (A-1) | (RA-1) |
| Composition | Water-soluble organic | DMAA | 9.8 | 9.5 | 9.8 | 9.8 | | 9.8 | 9.8 |
| (% By | monomer (a1) | ACMO | | | | | 9.8 | | |
| mass) | Phosphonic | LAPONITE | 2.3 | 4.6 | | 2.3 | 2.3 | 2.3 | |
| | acid-modified | RDS | | | | | | | |
| | hectorite (a2) | LAPONITE | | | 2.3 | | | | |
| | | S-482 | | | | | | | |
| | Synthetic | LAPONITE | | | | | | | 2.3 |
| | hectorite | RD | | | | | | | |
| | Pure water | | 87.9 | 85.9 | 87.9 | 87.9 | 87.9 | 87.9 | 87.9 |

| | | | | | | | |
|---|---|---|---|---|---|---|---|
| Viscosity after stored at 50° C. for 1 week (mPa · s) | 200 | 300 | 20 | 200 | 850 | 200 | 20,000 |
| Polymerization initiator (B) | NPS | NPS | NPS | NPS | NPS | KPS | — |
| Molar ratio [(B)/(a1)] | 0.02 | 0.02 | 0.02 | 0.04 | 0.028 | 0.004 | — |
| Evaluation | ◯ | ⊙ | ◯ | ◯ | Δ | X | — |

It was found that, in the method of the present invention in Example 1, an organic-inorganic hybrid hydrogel can be produced even in an air atmosphere.

In contrast, in Comparative Example 1 which is an example in which KPS having a solubility of less than 50 g/100 ml in water at 20° C. was used as the polymerization initiator (B), almost no polymerization proceeded, and an organic-inorganic hybrid hydrogel was not obtained.

In Comparative Example 2 which is an example in which synthetic hectorite which is not modified with phosphonic acid was used, the aqueous solution had poor storage stability, and an organic-inorganic hybrid hydrogel was not obtained.

1. A method for producing an organic-inorganic hybrid hydrogel, comprising:
a step of mixing an aqueous solution (A) containing a water-soluble organic monomer (a1) and a phosphonic acid-modified hectorite (a2), a polymerization initiator (B), and a polymerization promotor (C) with each other, wherein
the aqueous solution (A) has a viscosity of 1,000 mPa·s or less when stored at 50° C. for one week after preparation,
the polymerization initiator (B) has a solubility of 50 g/100 ml or more in water at 20° C., and
a molar ratio [(B)/(a1)] of the polymerization initiator (B) to the water-soluble organic monomer (a1) is in a range of 0.01 to 0.1.
